(19) United States
(12) Patent Application Publication
(10) Pub. No.: US 2026/0285084 A1
(43) Pub. Date: Sep. 24, 2026

(54) PORTABLE PAINT BUCKET WITH ACCESSORIES

(71) Applicants: John Paul Lalewicz, New Market, TN (US); Kenia Yolanda Torres Rogel, New Market, TN (US)

(72) Inventors: John Paul Lalewicz, New Market, TN (US); Kenia Yolanda Torres Rogel, New Market, TN (US)

(21) Appl. No.: 19/085,683

(22) Filed: Mar. 20, 2025

(51) Int. Cl. B44D 3/12; A47K 10/42

(52) U.S. Cl. CPC B44D 3/123; A47K 10/42; B44D 3/127

(57) ABSTRACT

A paint bucket includes a housing and a lid. The housing includes a sidewall and a base, and the housing defines a reservoir for receiving a supply of paint within the reservoir. A top end of the sidewall defines an opening providing access to the reservoir. The lid is attached to the housing and is movable relative to the top end of the housing to selectively close and open the opening to the reservoir. The paint bucket includes at least one brush container for receiving and enclosing a painting applicator. The paint bucket additionally includes a dispenser on the housing which may receive a supply of a sanitary paper or cloth and selectively dispense the sanitary paper or cloth from the paint bucket.

### FIELD OF THE INVENTION

This application relates to devices such as paint buckets or containers used to hold and/or convey a supply of paint or other liquids at a worksite.

### BACKGROUND

Painting generally involves the application of paint or other similar liquid to a surface (e.g., walls, floors, ceilings, objects and/or other structures, personal items, commercial items, vehicles, etc.). While various types of paint applicators may be used, the most common paint applicators include paint brushes and roller brushes.

Paint cans and other paint sources generally contain a large supply of paint, all of which may not be needed for a particular workspace or work area. As such, a paint bucket is commonly utilized at a work area to hold a supply of paint and to avoid repeated trips to the paint source. Thus, at a particular worksite or work area, a painter must keep track of not only the paint bucket but also paint applicators and any other accessories that he or she may want at the worksite or work area. Such responsibilities for the painter may make the painting job unnecessarily complicated and potentially dangerous (e.g., if the worksite or work area is at an elevation, up a ladder, etc.).

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a paint bucket includes a housing with a sidewall and a base. The housing defines a reservoir which may receive a supply of paint within the reservoir, and a top end of the sidewall defines an opening providing access to the reservoir. The paint bucket additionally includes a lid attached to the housing, and the lid is movable relative to the top end of the housing to selectively close and open the opening to the reservoir. In various embodiments, the paint bucket includes at least one brush container for receiving and enclosing a painting applicator. The at least one brush container is attachable to the paint bucket. In certain embodiments, the paint bucket includes a dispenser on the housing which is adapted to receive a supply of a sanitary paper or cloth and selectively dispense the sanitary paper or cloth from the paint bucket.

In some embodiments, at least one reservoir wall of the reservoir is inclined relative to vertical.

In certain embodiments, the paint bucket is a portable and/or a handheld paint bucket.

In various embodiments, the at least one brush container is attachable to the lid of the paint bucket. In some cases, the at least one brush container is configured to receive and enclose a roller cover of a roller brush as the painting applicator. In various embodiments, the paint bucket may include a handle support on the lid, the handle support configured to support a handle or frame of the roller brush. Optionally, the handle support is configured to engage the handle or frame of the roller brush such that a position of the lid relative to the housing is controllable by moving the handle or frame of the roller brush engaged with the handle support.

In some cases, the base of the housing defines a dispenser cavity for receiving the supply of the sanitary paper or cloth for the dispenser.

The lid may be movable between an open position and a closed position relative to the top end of the housing. In the open position, the lid enables access to the reservoir through the opening, and, in the closed position, the lid is engaged with the sidewall and prevents access to the reservoir through the opening. In some cases, in the closed position, the lid forms an air-tight seal with the sidewall such that the reservoir is sealed.

In various embodiments, the at least one brush container comprises a quick connect feature such that the at least one brush container is detachable from the paint bucket.

In certain embodiments, the paint bucket additionally includes a trash receptacle on the sidewall of the housing. Optionally, the trash receptacle includes a trash reservoir for receiving a supply of trash, a first opening to the trash reservoir arranged in a first direction, and a second opening to the trash reservoir arranged in a second direction that is orthogonal to the first direction.

In some embodiments, the paint bucket includes a handle on the housing, and the handle optionally is on an opposite end of the housing from the dispenser.

In various embodiments, the paint bucket may include a personnel engagement feature on the sidewall of the housing to engage a person handling the paint bucket. In some embodiments, the personnel engagement feature is different from a handle and is configured to engage the person without requiring the person to hold the paint bucket with his or her hand. In some cases, the personnel engagement feature allows for hands-free engagement between the paint bucket and the user. Optionally, the personnel engagement feature includes at least one of clips, clasps, hook and loop fasteners, adhesives, tapes, mechanical fasteners, snaps, friction fit members, hooks, buckles, sliding members, a snap-fit connectors, magnetic members, a quick release connector, or a magnetic member, combinations thereof, and/or as otherwise desired.

In some embodiments, the paint bucket includes a light on the housing. The light may be various types of lights as desired, and in one non-limiting example the light is a work light for selectively illuminating a work area (or as otherwise desired). Optionally, the light and the dispenser are on a same end of the housing. In other embodiments, the light may be on a sidewall of the housing, the lid of the paint bucket, and/or any other location as desired.

In certain embodiments, the lid is pivotably attached to the housing. Optionally, a hinge may connect the lid to the housing, although other devices or mechanisms may be utilized as desired.

In some cases, the at least one brush container is attachable to the sidewall of the housing, and the at least one brush container is configured to receive a paint brush or a roller brush as the painting applicator.

Optionally, the paint bucket includes a locking feature configured to engage the lid when the lid is in a closed position relative to the housing and to retain the lid in the closed position.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a top view of a paint bucket according to embodiments.

FIG. 2 is a front view of the paint bucket of FIG. 1 according to embodiments.

FIG. 3 is a side view of the paint bucket of FIG. 1 according to embodiments.

FIG. 4 is another side view of the paint bucket of FIG. 1 according to embodiments.

FIG. 5 is a top view of the paint bucket of FIG. 1 with a lid removed such that a reservoir of the paint bucket is visible according to embodiments.

FIG. 6 illustrates the paint bucket of FIG. 1 and a liner according to embodiments.

FIG. 7 is a top view of the paint bucket of FIG. 1 with the liner of FIG. 6 positioned within the reservoir and with a lid removed according to embodiments.

FIG. 8 is a bottom view of the paint bucket of FIG. 1 according to embodiments.

FIG. 9 is another bottom view of the paint bucket of FIG. 1 with a dispenser door opened according to embodiments.

FIG. 10 illustrates a person using a handle to engage the paint bucket of FIG. 1 according to embodiments.

FIG. 11 illustrates hands-free engagement between the person and the paint bucket of FIG. 1 according to embodiments.

FIG. 12 illustrates a personnel engagement feature of the paint bucket of FIG. 1 engaging a belt according to embodiments.

FIG. 13 illustrates the personnel engagement feature of FIG. 13 and a portion of the paint bucket of FIG. 1 according to embodiments.

### DETAILED DESCRIPTION

Described herein are paint buckets and associated systems and methods with improved portability and accessory management. In some embodiments, the paint buckets described herein may provide a bucket housing for receiving a supply of paint and which may be easily accessed by the user as desired. In certain embodiments, the paint buckets described herein further include a lid which may securely contain any paint within the bucket housing when not in use, thereby minimizing and/or preventing the paint from spilling when not in use. Optionally, the paint buckets described herein may provide an air-tight seal of the paint within the bucket housing when not in use. Various features may be utilized to provide such sealing, including various gaskets, rubber members, silicone members, combinations thereof, and/or other sealing members or features as desired. Optionally, a locking feature may be provided for selectively retaining the lid in a closed configuration relative to the bucket housing.

In certain embodiments, the paint buckets described herein may include brush containers for at least temporarily holding or storing a paint applicator when the paint applicator is not in use. In some cases, the brush containers may receive and enclose at least portions of various types of paint applicators as desired, including roller brushes, paint brushes, combinations thereof, and/or as otherwise desired. In certain embodiments, the brush containers described herein may accommodate various sizes of paint applicators as desired. As a non-limiting example, a brush container may accommodate a paint brush up to 3 inches wide, such as from 1 inch to 3 inches, such as from 2 inches to 3 inches. Other sizes may be accommodated as desired.

Optionally, the brush containers may include a quick connect feature such that the brush containers are detachable from the paint bucket. Quick connect features may include, but are not limited to, clips, clasps, hook and loop fasteners, adhesives, tapes, mechanical fasteners, snaps, friction fit members, combinations thereof, and/or other features or combinations of features as desired. In some embodiments, at least one brush container may receive and enclose at least a portion of the paint applicator such that the paint applicator may be utilized to position the lid relative to the bucket housing. The brush connectors detachable from and attachable to the paint bucket may improve the modularity of the paint bucket, allowing for a user to include various paint applicators on the paint bucket as desired.

In various embodiments, the paint bucket may include a personnel engagement feature on the housing to engage a person handling the paint bucket. In some cases, the personnel engagement feature allows for hands-free engagement between the paint bucket and the user. Optionally, the personnel engagement feature includes at least one of clips, clasps, hook and loop fasteners, adhesives, tapes, mechanical fasteners, snaps, friction fit members, hooks, buckles, sliding members, a snap-fit connectors, magnetic members, quick release connectors, combinations thereof, and/or as otherwise desired. The hands-free personnel engagement features may facilitate engagement and use by the person and may simplify engagement with the paint bucket.

In some embodiments, the paint buckets described herein may include a dispenser for selectively storing a supply of sanitary cloth or paper (e.g., wipes, wet wipes, paper towel, napkins, cloth, combinations thereof, and/or otherwise desired) and selectively dispensing such sanitary cloth or paper. Optionally, a trash receptacle may be provided on the paint bucket for receiving and temporarily storing trash generated at a worksite, such as but not limited to used sanitary cloth or paper.

In certain embodiments, the paint buckets described herein may include a personnel engagement feature allowing for hands-free engagement between a user and the paint bucket. The personnel engagement feature may be provided at various locations as desired, and in one non-limiting example may be provided on a sidewall of the housing. The hands-free engagement may allow for a user to retain the paint bucket (and associated accessories) on the user while the user is free to maintain use of his or her hands (e.g., to continue painting, climb a ladder, etc.).

Optionally, the paint buckets described herein a light on the housing, such as a work light for selectively illuminating a work area (or as otherwise desired).

The aforementioned accessories included on and/or within the paint buckets described herein may generally improve the availability of accessories to a user at a worksite and thereby facilitate a painting process. Various other benefits and advantages may be realized with the systems and methods described herein, and the aforementioned benefits and advantages should not be considered limiting.

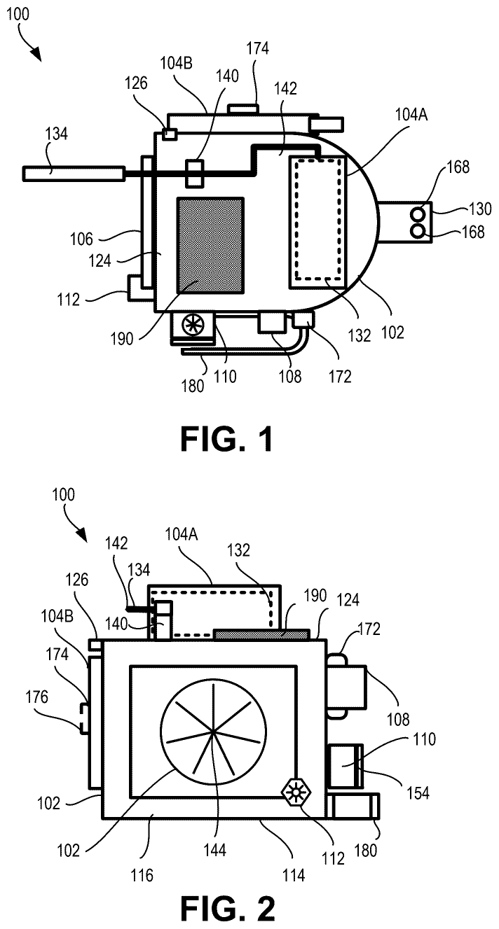

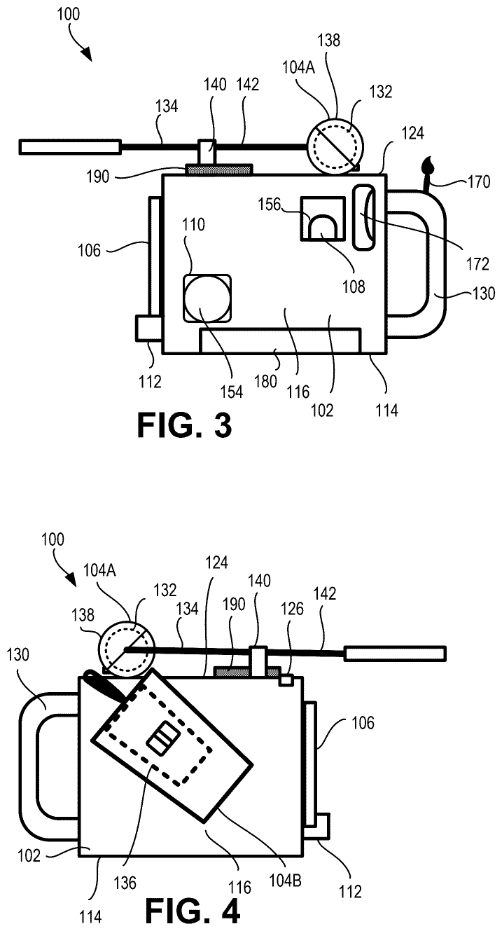

FIGS. 1-13 illustrate a paint bucket 100 according to embodiments. The paint bucket 100 generally includes a housing 102. The housing 102 of the paint bucket 100 generally includes a base 114 and a sidewall 116. Optionally, and as illustrated in FIGS. 1, 4, and 6, the housing 102 includes a handle 130 extending outwards from the sidewall 116 which may be gripped or otherwise handled by a user as desired. Optionally, and as illustrated in FIG. 1, for example, the handle 130 may include one or more integrated brush holders 168. The integrated brush holders 168 may be utilized for holding a paint applicator 170 such as but not limited to a brush as illustrated in FIG. 3. In some embodiments, the integrated brush holders 168 may include apertures and/or cavities defined in the handle 130, although other types of integrated brush holders 168 may be formed as desired. The number, size, and location of the integrated brush holders 168 should not be considered limiting on the disclosure.

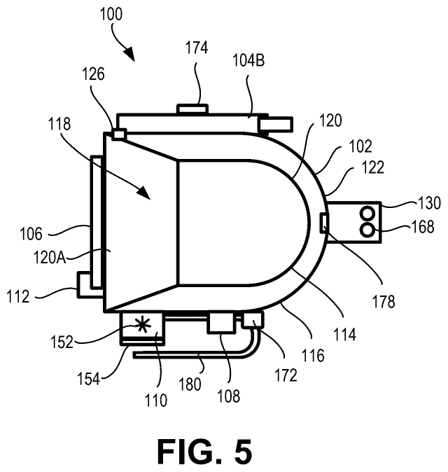

As illustrated in FIG. 5, the base 114 and sidewall 116 define a reservoir 118 for receiving a supply of paint. An opening 122 for the reservoir 118 may be defined at a top end of the paint bucket 100. In various embodiments, the reservoir 118 includes one or more reservoir walls 120. Optionally, at least one reservoir wall 120A may be inclined or angled relative to a vertical axis. In such embodiments, the inclined reservoir wall 120A may facilitate removal of paint from a paint applicator by a user. In other embodiments, an insert may be provided at least partially within the reservoir (in addition to or in place of the inclined reservoir wall 120A), and the insert may have or form an inclined or angled surface within the reservoir.

In various embodiments, and as best illustrated in FIG. 5, the paint bucket 100 optionally includes a support 178 within the reservoir 118 configured to temporarily support a paint applicator (such as but not limited to a brush or roller) within the reservoir 118. Optionally, the support 178 may hold the paint applicator in an upright position while not allowing the paint applicator to slide into paint in the reservoir 118 (e.g., if a user needs to let go of the paint applicator while in the midst of painting). Various supports 178 may be utilized as desired, such as but not limited to clips, clasps, hook and loop fasteners, adhesives, tapes, mechanical fasteners, snaps, friction fit members, hooks, buckles, sliding members, a snap-fit connectors, magnetic members, quick release connectors, combinations thereof, and/or as otherwise desired. In the embodiment illustrated, the support 178 is a magnetic member within the reservoir 118.

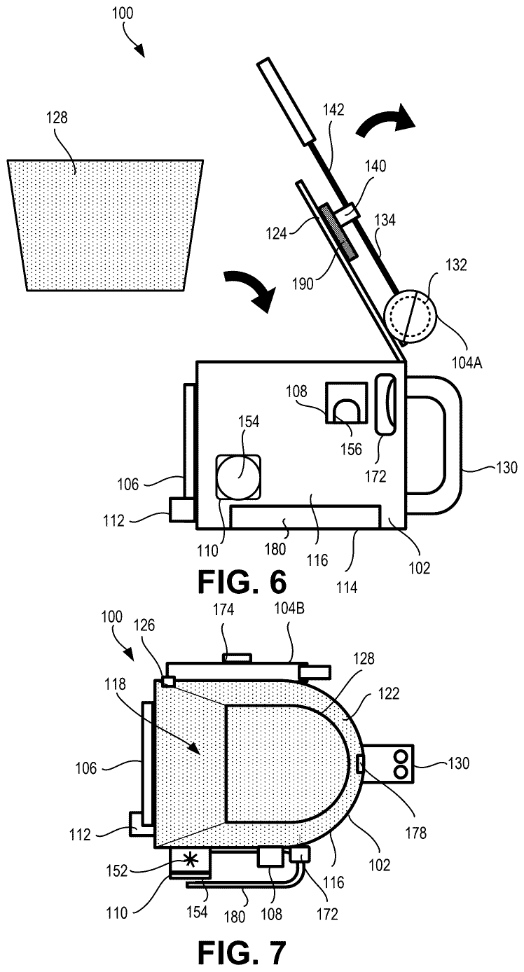

As illustrated in FIGS. 1 and 6, the paint bucket 100 includes a lid 124 attached to the housing 102 and movable relative to the housing 102 to selectively provide or prevent access to the reservoir 118. The lid 124 may be movable using various techniques or mechanisms as desired. In one non-limiting example, the lid 124 may be pivotably attached to the housing 102 via a hinge or other suitable mechanism as desired.

In various embodiments, the lid 124 is movable between a closed position (FIG. 1) and an open position (FIG. 6). In the closed position, the lid 124 may cover the opening 122 to the reservoir 118, thereby enclosing the reservoir 118 and any contents (e.g., paint) contained therein. In certain embodiments, in the closed position, the lid 124 may engage the sidewall 116 of the housing 102. Optionally, the engagement between the lid 124 and the sidewall 116 is a sealed engagement such that an air-tight seal is formed between the lid 124 and the sidewall 116. In such embodiments, the lid 124 and/or the sidewall 116 may include various features to provide such sealing, including various gaskets, rubber members, silicone members, combinations thereof, and/or other sealing members or features as desired. The lid 124 forming the seal with the sidewall 116 may further improve storage of any paint contained within the reservoir 118.

Optionally, a locking member 126 may be utilized to selectively retain the lid 124 in the closed position. The locking member 126 may be various devices or mechanisms as desired suitable for engaging and maintaining the lid 124 in the closed position, such as but not limited to clips, clasps, hooks, snaps, mechanical fasteners, hook and loop fasteners, cords, magnets, straps, combinations thereof, and/or other suitable features as desired. While a single locking member 126 is illustrated, in other embodiments, the paint bucket 100 may include any number of locking members 126 at various locations as desired suitable for closing the lid 124.

In the open position of the lid 124, as illustrated in FIG. 6, the lid 124 enables access to the reservoir 118 through the opening 122. In some embodiments, in the open position, paint may be introduced into the reservoir. Optionally, and as illustrated in FIGS. 6 and 7, a liner 128 may be positioned within the reservoir 118 for providing a barrier between the housing 102 and the paint within the reservoir 118. In some embodiments, the liner 128 may be a disposable liner 128 which may be replaced after each use.

In addition to the housing 102, the paint bucket 100 may include one or more accessories on the housing 102 for facilitating and/or improving a work environment of a person using the paint bucket 100. Accessories include, but are not limited to, one or more brush containers 104, one or more dispensers 106, one or more personnel engagement features 108, one or more trash receptacles 110, one or more lights 112, combinations thereof, and/or other accessories as desired. The number of accessories illustrated in FIGS. 1-13 should not be considered limiting, and in other embodiments, the paint bucket 100 may include fewer or additional accessories as desired. Moreover, the number of a particular type of accessory illustrated in FIGS. 1-13 should not be considered limiting, and in other embodiments, the paint bucket 100 may include any number of a particular type of accessory as desired.

In various embodiments, the accessories include one or more brush containers 104. In the embodiment illustrated in FIGS. 1-13, the paint bucket 100 includes two brush containers 104A-B, where the brush container 104A is on the lid 124 of the paint bucket 100 and the brush container 104B is on the sidewall 116. In other embodiments, the brush containers 104 may be provided at other locations or combinations of locations as desired.

The brush containers 104 may be adapted to hold various types of paint applicators as desired. In FIGS. 1-13, brush container 104A is configured to receive and enclose a roller cover 132 of a roller brush 134 as the painting applicator, and brush container 104B is configured to receive and enclose a paint brush 136 as the painting applicator. In certain embodiments, the brush containers 104 may be selectively opened or closed to allow positioning of the portion of the paint applicator within the particular brush container 104. As a non-limiting example, and as illustrated in FIG. 3, the brush container 104A may include a lid component 138 that may be selectively opened or closed for positioning of the roller cover 132.

In embodiments where the brush container 104A is provided on the lid 124, the lid 124 may include a handle support 140 on the lid 124 for selectively engaging the handle or frame of the paint applicator. In the embodiment illustrated, the handle support 140 is engaged with a frame 142 of the roller brush 134. In certain embodiments, the handle support 140 may engage the handle or frame of the paint applicator such that a user may utilize the handle or frame of the paint applicator to position the lid 124 (see, e.g., FIG. 6).

In certain embodiments, the brush containers 104 include various quick connect features such that the brush containers 104 may be selectively attached to or detached from the paint bucket as desired. Quick connect features may include, but are not limited to, clips, clasps, hook and loop fasteners, adhesives, tapes, mechanical fasteners, snaps, friction fit members, combinations thereof, and/or other features or combinations of features as desired. Brush containers 104 with quick connect features may improve modularity of the paint bucket 100, and paint applicators of various types and sizes may be selectively added to or detached from the paint bucket 100 as desired. In other embodiments, at least one brush container 104 optionally may be fixed relative to the paint bucket 100 (e.g., cannot be removed without disassembly).

Additionally, or alternatively, to the one or more brush containers, the one or more accessories include one or more dispensers 106 for selectively dispensing sanitary cloth or paper 146 (see FIG. 9). In some embodiments, and as illustrated in FIGS. 1 and 3, for example, the dispenser 106 may be provided on an end of the housing 102 opposite from the handle 130. However, in other embodiments, the dispenser 106 may be provided at various other locations as desired.

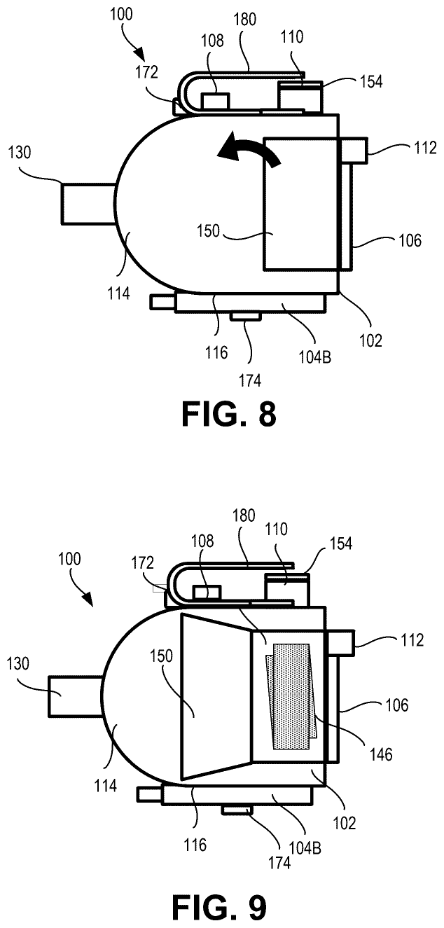

As illustrated in FIG. 2, the dispenser 106 generally includes a dispenser opening 144 through which the sanitary cloth or paper 146 may be dispensed. The sanitary cloth or paper 146 may be dispensed automatically or manually (e.g., a user may pull the sanitary cloth or paper 146 through the dispenser opening 144) as desired. The sanitary cloth or paper may be various products or materials usable at a painting worksite (e.g., to clean a spill, wipe a surface, wipe another accessory, etc.), such as but not limited to wipes, wet wipes, paper towel, napkins, cloth, combinations thereof, and/or otherwise desired. In some embodiments, and as best illustrated in FIGS. 8 and 9, the housing 102 may include a dispenser cavity 148 for receiving a supply of the sanitary cloth or paper 146. Optionally, the base 114 includes an access door 150 providing access to the dispenser cavity 148. In other embodiments, an access door may be provided on the sidewall 116 or other location as desired.

In certain embodiments, the paint bucket 100 may include the one or more trash receptacles 110, which include a reservoir which may be utilized to at least temporarily store trash at the work area. In non-limiting examples, the one or more trash receptacles 110 may be utilized to retain used sanitary cloth or paper 146.

The trash receptacles 110 may be provided at various locations on the housing 102 as desired. In the embodiments illustrated in FIGS. 1-13, a trash receptacle 110 is provided on the sidewall 116 of the housing 102. In some embodiments, the trash receptacles 110 are fixedly attached to the housing 102, while in other embodiments, the trash receptacles 110 may be attachable to and detachable from the housing 102 as desired.

In some embodiments, the trash receptacles include at least one opening 152 providing access to the reservoir of the trash receptacle, and in some embodiments, the trash receptacles 110 may include a plurality of openings 152. Optionally, a lid 154 may selectively cover at least one opening 152. In embodiments with a plurality of openings 152, the openings may be arranged in or face a plurality of directions. In the embodiment illustrated in FIGS. 1-13, the trash receptacle 110 includes a first opening 152 arranged in a first direction, and a second opening (covered by the lid 154) arranged in a second direction that is orthogonal to the first direction. In one non-limiting example, the first opening 152 without a lid 154 may be utilized for placing trash within the trash receptacle 110, and the second opening with the lid 154 may be utilized for removing trash from the trash receptacle 110.

In various embodiments, the one or more accessories included with the paint bucket 100 may additionally or alternatively include the one or more personnel engagement features 108. The one or more personnel engagement features 108 may enable hands-free engagement between the user and the paint bucket 100 (compared to the handle 130). In various embodiments, the one or more personnel engagement features 108 are provided on the sidewall 116 of the housing 102. In some embodiments, the one or more personnel engagement features 108 may be fixedly attached to the housing to provide a secure connection point between the paint bucket 100 and the user.

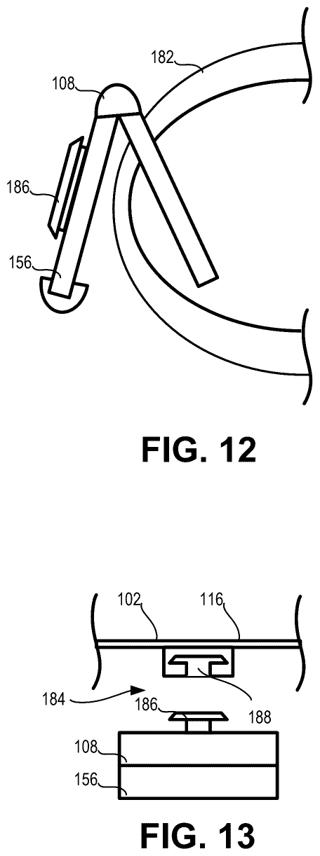

In certain embodiments, the one or more personnel engagement features 108 may engage an article of clothing and/or other equipment or devices worn and/or on the person. In one non-limiting example, the one or more personnel engagement features 108 may be configured to engage a belt, a strap, a hook, a clip, a pocket, a loop, a magnetic feature, and/or other feature on the person. Non-limiting examples of the one or more personnel engagement features 108 include, but are not limited to clips, clasps, hook and loop fasteners, adhesives, tapes, mechanical fasteners, snaps, friction fit members, hooks, buckles, sliding members, a snap-fit connectors, magnetic members, quick release connectors, combinations thereof, and/or as otherwise desired. In the embodiment of FIGS. 1-13, and as best illustrated in FIG. 12, the personnel engagement feature 108 includes a clip 156 configured to engage a belt 182 or other similar feature on the user.

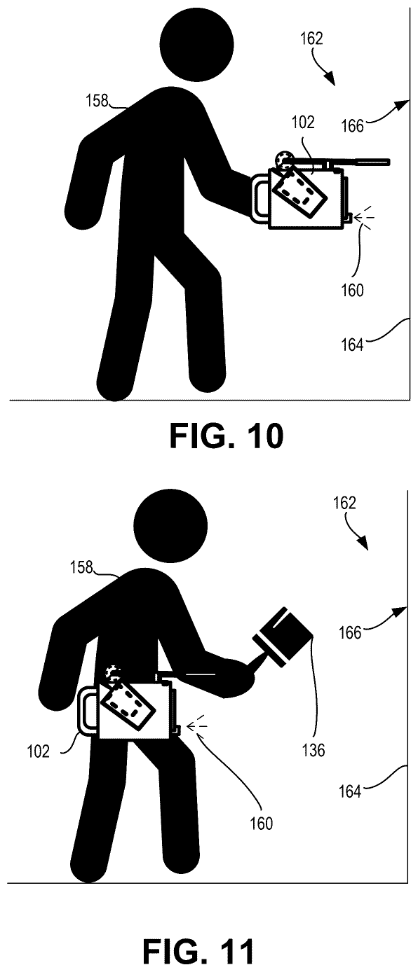

With reference to FIGS. 10 and 11, the handle 130 and the personnel engagement feature 108 may allow for various types of engagement between a user 158 and the paint bucket 100 and improved handling and portability. As non-limiting examples, the improved, portable paint bucket 100 may allow for hand engagement (using handle 130) as illustrated in FIG. 10 or hands-free engagement (using personnel engagement feature 108) as illustrated in FIG. 11. Hands-free engagement may allow for the user 158 to utilize other accessories (such as the paint brush 136) and/or otherwise enable use of his or her hands while keeping the paint bucket 100 at a close and convenient location, further improving the portability of the paint bucket 100.

Optionally, the one or more accessories included with the paint bucket 100 includes one or more lights 112. The one or more lights 112 may be various types of lights or light sources as desired. In one non-limiting example, the one or more lights 112 may be a work light capable of at least partially illuminating a work area. The one or more lights 112 may be provided at various locations on the paint bucket 100 as desired. In the embodiment illustrated in FIGS. 1-13, the light 112 is provided on the end of the paint bucket 100 opposite from the handle 130 and further on the sidewall 116. However, in other embodiments, the light 112 may be provided on other portions of the sidewall 116 and/or the lid 124 as desired. As illustrated in FIGS. 10 and 11, for example, a light emission 160 from the light 112 may be utilized to improve visibility to a work area 162, such as but not limited to a wall 164 with a surface 166 being painted.

Optionally, the one or more accessories included with the paint bucket 100 includes a tool 172 such as but not limited to a five-in-one tool, a utility knife, a putty knife, combinations thereof, and/or other tools as desired. The tool 172 may be attached to the housing 102 using various quick connect features as desired such that the tool 172 is selectively attached to and removable from the paint bucket 100 as desired. The number, type, and location of the tool 172 on the housing 102 should not be considered limiting.

In some embodiments, the paint bucket 100 optionally includes one or more supplemental holders 174 for selectively holding additional tools and/or components relative to the paint bucket 100. In some embodiments, the supplemental holders 174 may be a quick connectors such as but not limited to clips, clasps, hook and loop fasteners, adhesives, tapes, mechanical fasteners, snaps, friction fit members, hooks, buckles, sliding members, a snap-fit connectors, magnetic members, quick release connectors, combinations thereof, and/or other suitable features as desired. The supplemental holders 174 may be provided on the housing 102 and/or other component as desired. In the embodiment illustrated, the supplemental holder 174 includes a clip 176 for a putty knife (or other tool) on the brush holder 104B. However, as mentioned, other locations may be utilized as desired, and any number of supplemental holders 174 may be utilized as desired.

In certain embodiments, the one or more accessories for the paint bucket 100 includes a spacer bar 180 on the housing 102. When the spacer bar 180 is included, the spacer bar 180 may be utilized to maintain a proper and/or desired positioning of the paint bucket 100 relative to the user. In some embodiments, the spacer bar 180 is optionally provided on a portion of the sidewall 116 opposite from the brush holder 104B; however, in other embodiments, the spacer bar 180 may be provided at other locations as desired. The spacer bar 180 may have various shapes or profiles as desired suitable for positioning and/or orienting the paint bucket 100 relative to the user. In the embodiment illustrated, the spacer bar 180 has a generally U-shaped profile; however, other profiles (or combinations thereof) may be utilized as desired.

In various embodiments, the one or more accessories for the paint bucket 100 includes a sanding block 190 attachable to the paint bucket 100. In the embodiment illustrate, the sanding block 190 is attached to the lid 124; however, in other embodiments, the sanding block 190 may be attached to other portions of the paint bucket 100, such as but not limited to the housing 102, as desired. Similar to other accessories, the sanding block 190 may include a quick connect feature such that the sanding block 190 is selectively attachable to and removable from the paint bucket 100 as desired.

As mentioned, various quick connect features may be utilized to selectively join various accessories with the paint bucket 100, such as but not limited to one or more of clips, clasps, hook and loop fasteners, adhesives, tapes, mechanical fasteners, snaps, friction fit members, hooks, buckles, sliding members, a snap-fit connectors, magnetic members, a quick release connector, or a magnetic member, combinations thereof, and/or as otherwise desired. In addition for enabling attachment and detachment of accessories, the quick connect features may allow for the accessories to be repositioned at various locations on the paint bucket 100 as desired.

With reference to FIGS. 12 and 13, in one non-limiting example, the quick connector features may include a sliding feature 184 with a rail 186 on one component (e.g., the accessory) and a groove 188 on the other component (e.g., the paint bucket 100), or vice versa. In FIGS. 12 and 13, the personnel engagement feature 108 is illustrated with the rail 186 and the sidewall 116 of the paint bucket 100 is illustrated with the groove 188. In certain embodiments, the sliding feature 184 may allow for sliding movement of the accessory relative to the paint bucket 100. The sliding feature 184 may include various stoppers or other features for selectively maintaining engagement between the rail 186 and the groove 188. As a non-limiting example, a certain amount of force may be required to disengage the rail 186 and the groove 188. Other features or combinations thereof may be utilized as desired. Moreover, while the sliding feature 184 is illustrated with the personnel engagement feature 108, in other embodiments, the sliding feature 184 may be provided on other accessories as desired. As a non-limiting example, the sliding features 184 may be provided with the brush holder 104B. In embodiments with a plurality of accessories, the quick connect features may be a same type of quick connect feature (e.g., all clips) or various combinations of quick connect features as desired.

The aforementioned accessories are for illustrative purposes, and in other embodiments the paint bucket 100 may include fewer and/or additional accessories as desired and in various combinations as desired. Regardless, the paint bucket 100 provides the user 158 with an improved availability of accessories to a user at a worksite and thereby facilitate a painting process. Various other benefits and advantages may be realized with the systems and methods described herein, and the aforementioned benefits and advantages should not be considered limiting.

A collection of exemplary embodiments are provided below, including at least some explicitly enumerated as “Examples” providing additional description of a variety of example embodiments in accordance with the concepts described herein. These examples are not meant to be mutually exclusive, exhaustive, or restrictive; and the disclosure not limited to these example illustrations but rather encompasses all possible modifications and variations within the scope of the issued claims and their equivalents.

Example 1. A paint bucket comprising: a housing comprising a sidewall and a base, the housing defining a reservoir configured to receive a supply of paint within the reservoir, wherein a top end of the sidewall defines an opening providing access to the reservoir; a lid attached to the housing and movable relative to the top end of the housing to selectively close and open the opening to the reservoir; at least one brush container for receiving and enclosing a painting applicator, the at least one brush container attachable to paint bucket; and a dispenser on the housing, the dispenser configured to receive a supply of a sanitary paper or cloth and selectively dispense the sanitary paper or cloth from the paint bucket.

Example 2. The paint bucket of any preceding or subsequent examples or combination of examples, wherein at least one reservoir wall of the reservoir is inclined relative to vertical.

Example 3. The paint bucket of any preceding or subsequent examples or combination of examples, wherein the at least one brush container is attachable to the lid of the paint bucket.

Example 4. The paint bucket of any preceding or subsequent examples or combination of examples, wherein the at least one brush container is configured to receive and enclose a roller cover of a roller brush as the painting applicator.

Example 5. The paint bucket of any preceding or subsequent examples or combination of examples, further comprising a handle support on the lid, the handle support configured to support a handle or frame of the roller brush.

Example 6. The paint bucket of any preceding or subsequent examples or combination of examples, wherein the handle support is configured to engage the handle or frame of the roller brush such that a position of the lid relative to the housing is controllable by moving the handle or frame of the roller brush engaged with the handle support.

Example 7. The paint bucket of any preceding or subsequent examples or combination of examples, wherein the base of the housing defines a dispenser cavity for receiving the supply of the sanitary paper or cloth for the dispenser.

Example 8. The paint bucket of any preceding or subsequent examples or combination of examples, wherein the lid is movable between an open position and a closed position relative to the top end of the housing, wherein, in the open position, the lid enables access to the reservoir through the opening, and wherein, in the closed position, the lid is engaged with the sidewall and prevents access to the reservoir through the opening.

Example 9. The paint bucket of any preceding or subsequent examples or combination of examples, wherein, in the closed position, the lid forms an air-tight seal with the sidewall such that the reservoir is sealed.

Example 10. The paint bucket of any preceding or subsequent examples or combination of examples, wherein the at least one brush container comprises a quick connect feature such that the at least one brush container is detachable from the paint bucket.

Example 11. The paint bucket of any preceding or subsequent examples or combination of examples, further comprising a trash receptacle on the sidewall of the housing.

Example 12. The paint bucket of any preceding or subsequent examples or combination of examples, wherein the trash receptacle comprises a trash reservoir for receiving a supply of trash, a first opening to the trash reservoir arranged in a first direction, and a second opening to the trash reservoir arranged in a second direction that is orthogonal to the first direction.

Example 13. The paint bucket of any preceding or subsequent examples or combination of examples, further comprising a handle on the housing, wherein the handle is on an opposite end of the housing from the dispenser.

Example 14. The paint bucket of any preceding or subsequent examples or combination of examples, further comprising a personnel engagement feature on the sidewall of the housing, the personnel engagement feature configured to engage a person handling the paint bucket.

Example 15. The paint bucket of any preceding or subsequent examples or combination of examples, wherein the personnel engagement feature comprises at least one of a clip, a clasp, a hook, a buckle, a sliding member, a snap-fit connector, a quick release connector, or a magnetic member.

Example 16. The paint bucket of any preceding or subsequent examples or combination of examples, further comprising a light on the housing.

Example 17. The paint bucket of any preceding or subsequent examples or combination of examples, wherein the light and the dispenser are on a same end of the housing

Example 18. The paint bucket of any preceding or subsequent examples or combination of examples, wherein the lid is pivotably attached to the housing.

Example 19. The paint bucket of any preceding or subsequent examples or combination of examples, wherein the at least one brush container is attachable to the sidewall of the housing, and wherein the at least one brush container is configured to receive a paint brush or a roller brush as the painting applicator.

Example 20. The paint bucket of any preceding or subsequent examples or combination of examples, further comprising a locking feature configured to engage the lid when the lid is in a closed position relative to the housing and to retain the lid in the closed position.

As used herein, the terms “invention,” “the invention,” “this invention,” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention, and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A paint bucket comprising:
a housing comprising a sidewall and a base, the housing defining a reservoir configured to receive a supply of paint within the reservoir, wherein a top end of the sidewall defines an opening providing access to the reservoir;
a lid attached to the housing and movable relative to the top end of the housing to selectively close and open the opening to the reservoir;
at least one brush container for receiving and enclosing a painting applicator, the at least one brush container attachable to paint bucket; and
a dispenser on the housing, the dispenser configured to receive a supply of a sanitary paper or cloth and selectively dispense the sanitary paper or cloth from the paint bucket.

2. The paint bucket of claim 1, wherein at least one reservoir wall of the reservoir is inclined relative to vertical.

3. The paint bucket of claim 1, wherein the at least one brush container is attachable to the lid of the paint bucket.

4. The paint bucket of claim 3, wherein the at least one brush container is configured to receive and enclose a roller cover of a roller brush as the painting applicator.

5. The paint bucket of claim 4, further comprising a handle support on the lid, the handle support configured to support a handle or frame of the roller brush.

6. The paint bucket of claim 5, wherein the handle support is configured to engage the handle or frame of the roller brush such that a position of the lid relative to the housing is controllable by moving the handle or frame of the roller brush engaged with the handle support.

7. The paint bucket of claim 1, wherein the base of the housing defines a dispenser cavity for receiving the supply of the sanitary paper or cloth for the dispenser.

8. The paint bucket of claim 1, wherein the lid is movable between an open position and a closed position relative to the top end of the housing, wherein, in the open position, the lid enables access to the reservoir through the opening, and wherein, in the closed position, the lid is engaged with the sidewall and prevents access to the reservoir through the opening.

9. The paint bucket of claim 8, wherein, in the closed position, the lid forms an air-tight seal with the sidewall such that the reservoir is sealed.

10. The paint bucket of claim 1, wherein the at least one brush container comprises a quick connect feature such that the at least one brush container is detachable from the paint bucket.

11. The paint bucket of claim 1, further comprising a trash receptacle on the sidewall of the housing.

12. The paint bucket of claim 11, wherein the trash receptacle comprises a trash reservoir for receiving a supply of trash, a first opening to the trash reservoir arranged in a first direction, and a second opening to the trash reservoir arranged in a second direction that is orthogonal to the first direction.

13. The paint bucket of claim 1, further comprising a handle on the housing, wherein the handle is on an opposite end of the housing from the dispenser.

14. The paint bucket of claim 1, further comprising a personnel engagement feature on the sidewall of the housing, the personnel engagement feature configured to engage a person handling the paint bucket.

15. The paint bucket of claim 14, wherein the personnel engagement feature comprises at least one of a clip, a clasp, a hook, a buckle, a sliding member, a snap-fit connector, a quick release connector, or a magnetic member.

16. The paint bucket of claim 1, further comprising a light on the housing.

17. The paint bucket of claim 16, wherein the light and the dispenser are on a same end of the housing.

18. The paint bucket of claim 1, wherein the lid is pivotably attached to the housing.

19. The paint bucket of claim 1, wherein the at least one brush container is attachable to the sidewall of the housing, and wherein the at least one brush container is configured to receive a paint brush or a roller brush as the painting applicator.

20. The paint bucket of claim 1, further comprising a locking feature configured to engage the lid when the lid is in a closed position relative to the housing and to retain the lid in the closed position.
